(19) United States
(12) Patent Application Publication
(10) Pub. No.: US 2012/0278053 A1
(43) Pub. Date: Nov. 1, 2012

(54) Method of Providing Flow Control Devices for a Production Wellbore

(75) Inventors: Gonzalo A. Garcia, Katy, TX (US); Luis A. Garcia, Houston, TX (US); Ronnie D. Russell, Cypress, TX (US)

(73) Assignee: BAKER HUGHES INCORPORATED, Houston, TX (US)

(21) Appl. No.: 13/096,541

(22) Filed: Apr. 28, 2011

(51) Int. Cl. G06G 7/57

(52) U.S. Cl. 703/10

(57) ABSTRACT

A method of providing a production string for a wellbore formed in a formation is disclosed. The method, in one embodiment may include: defining a performance criterion for flow of a fluid from a formation into a wellbore; performing a simulation using a processor, a simulation program, a parameter of the fluid, a parameter of the formation and a parameter of the wellbore to determine a first flow characteristic of the flow of the fluid from the formation into the wellbore corresponding to an initial set of flow control devices arranged in the wellbore; performing one or more additional simulations using the processor, the simulation program and the parameters of formation, fluid and wellbore to determine a new flow characteristic of the flow of the fluid from the formation into the wellbore for a new set of flow control devices until a new determined characteristic of the flow of the fluid from the formation into the wellbore meets the performance criterion; and storing results of simulation results relating to the flow control devices in a suitable storage medium.

### BACKGROUND OF THE DISCLOSURE

1. Field of the Disclosure

The disclosure relates generally to apparatus and methods for control of fluid flow From subterranean formations into a production string in a wellbore.

2. Description of the Related Art

Hydrocarbons such as oil and gas are recovered from a subterranean formation using a well or wellbore drilled into the formation. In some cases the wellbore is completed by placing a casing along the wellbore length and perforating the casing adjacent each production zone (hydrocarbon bearing zone) to extract fluids (such as oil and gas) from such a production zone. In other cases, the wellbore may be open hole. One or more inflow control devices are placed in the wellbore to control flow of fluids into the wellbore. These flow control devices and production zones are generally separated from each other by installing a packer between them. Fluid from each production zone entering the wellbore is drawn into a tubing that runs to the surface. The fluid moves from the reservoir to the annular space to the inflow control device and finally to the base pipe. The annular space can be gravel packed or not. It is desirable to have a substantially even flow of fluid along the production zone. Uneven drainage may result in undesirable conditions such as invasion of a gas cone or water cone. In the instance of an oil-producing well, for example, a gas cone may cause an in-flow of gas into the wellbore that could significantly reduce oil production. In like fashion, a water cone may cause an in-flow of water into the oil production flow that reduces the amount and quality of the produced oil.

A deviated, horizontal or vertical wellbore is often drilled into a production zone to extract fluid from the production zone. Several inflow control devices are placed spaced apart along such a wellbore to drain formation fluid or to inject a fluid into the formation. Formation fluid often contains a layer of oil, a layer of water below the oil and a layer of gas above the oil. For production wells, the horizontal wellbore is typically placed above the water layer. The boundary layers of oil, water and gas may not be even along the entire length of the horizontal well. Also, certain properties of the formation, such as porosity and permeability, may not be the same along the well length. Therefore, fluid between the formation and the wellbore may not flow evenly through the inflow control devices. For production wellbores, it is desirable to have a relatively even flow of the production fluid into the wellbore and also to inhibit the flow of water and gas through each inflow control device. Active flow control devices have been used to control the fluid from the formation into the wellbores. Such devices are relatively expensive and include moving parts, which require maintenance and may not be very reliable over the life of the wellbore. Passive inflow control devices (“ICDs”) that are able to restrict flow of water into the wellbore are therefore desirable.

The disclosure herein provides a method for selecting passive ICDs to complete a wellbore that in one aspect maintain a substantially constant flow of fluids from the formation.

### SUMMARY

A method of providing a production string for a wellbore formed in a formation is disclosed. The method, in one embodiment, may include: defining a performance criterion for flow of a fluid from a formation into a wellbore; performing a simulation using a processor, a simulation program, a parameter of the fluid, a parameter of the formation and a parameter of the wellbore to determine a first flow characteristic of the flow of the fluid from the formation into the wellbore corresponding to an initial set of flow control devices arranged in the wellbore; performing one or more additional simulations using the processor, the simulation program and the parameters of formation, fluid and wellbore to determine a new flow characteristic of the flow of the fluid from the formation into the wellbore for a new set of flow control devices until a new determined characteristic of the flow of the fluid from the formation into the wellbore meets the performance criterion; and storing results of simulation results relating to the flow control devices in a suitable storage medium.

In another aspect, a computer-readable medium, accessible to a processor for executing instructions contained in program embedded in the computer-readable medium is provided. In one embodiment, the program may include: instructions to select a performance criterion for flow of a fluid from a formation into a wellbore; instructions to use a simulation program, a parameter of the fluid, a parameter of the formation and a parameter of the wellbore to determine an initial flow characteristic of the flow of the fluid from the formation into the wellbore corresponding to an initial set of flow control devices arranged along the wellbore; instructions, when the performance criterion is not met, to perform one or more simulation using the simulation program, a new set of flow control devices, the formation parameter, fluid parameter and the wellbore parameter to determine a characteristic of the flow of the fluid from the formation into the wellbore that meets the performance criterion; and storing a simulation result relating to the set of flow control devices that meet the performance criterion.

Examples of the more important features of the disclosure have been summarized rather broadly in order that detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawings, in which like reference characters generally designate like or similar elements throughout the several figures of the drawing, and wherein:

FIG. 1 is a schematic diagram of an exemplary multi-zone wellbore that has a production string installed therein, which production string includes a number of ICDs placed at selected locations along the length of the production string in accordance with one embodiment of the disclosure;

FIG. 2 is a block diagram of an exemplary system to determine a production string layout and ICD configuration for a wellbore in accordance with one embodiment of the disclosure;

FIG. 3 is a chart of an exemplary routine for determining a production string layout and ICD configuration in accordance with one embodiment of the disclosure;

FIG. 4A is a graph showing an exemplary desired relationship between Reynolds number and a pressure loss coefficient for a flow control device to control water or gas flow in an oil well application, in accordance with one embodiment of the disclosure;

FIG. 4B is a graph showing an exemplary desired relationship between Reynolds number and a pressure loss coefficient for a flow control device to control water flow, in a gas well application, in accordance with one embodiment of the disclosure; and

FIG. 5 is a detailed schematic diagram of a portion of an exemplary drill string that includes flow control devices in accordance with one embodiment of the disclosure.

### DETAILED DESCRIPTION OF THE DISCLOSURE

The present disclosure relates to apparatus and methods for controlling flow of formation fluids into a well. The present disclosure provides certain drawings and describes certain embodiments of the apparatus and methods, which are to be considered exemplification of the principles described herein and are not intended to limit the disclosure to the illustrated and described embodiments.

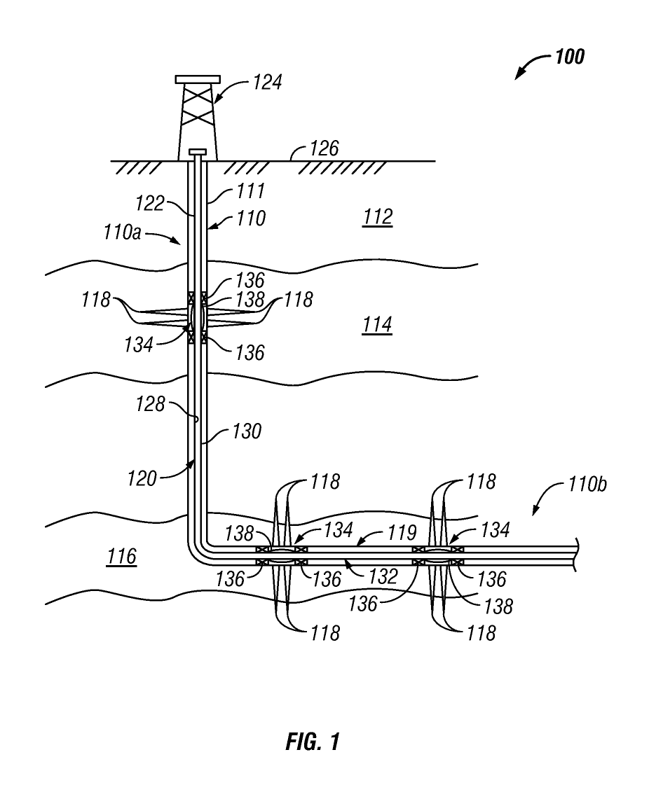

FIG. 1 shows an exemplary fluid production system 100 that includes a wellbore 110 drilled through an earth 112 and into a pair of production zones or reservoirs 114, 116 from which the production of hydrocarbons is desired. The wellbore 110 is shown lined with a casing 111 having a number of perforations 118 that penetrate and extend into the formations production zones 114, 116 so that production fluids may flow from the production zones 114, 116 into the wellbore 110. The well completion may be cased or open hole and the production devices 134 may be installed in both completion types. The exemplary wellbore 110 is shown to include a vertical section 110a and a substantially horizontal section 110b. The wellbore 110 includes a production string (or completion string or production assembly) 120 that includes a tubing (also referred to as the base pipe or tubular) 122 that extends downwardly from a wellhead 124 at the surface 126 of the wellbore 110. The production string 120 defines an internal axial bore 128 along its length. An annulus 130 is defined between the production string 120 and the wellbore casing. The annulus may be gravel packed. The production string 120 has a deviated, generally horizontal portion 132 that extends along the horizontal section 110b of the wellbore 110. Production devices 134 are positioned at selected locations along the production string 120. Production devices 134 may be installed in vertical wells wherein the reservoir thickness is long enough for installation of more than one production device 134. Normally, the production devices 134 are installed in production zones, such as production zones 114, 116, in sections with lower flow resistance in the porous media. Optionally, each production device 134 may be isolated within the wellbore 110 by a pair of packer devices 136. Although only two production devices 134 are shown along the horizontal portion 132, there may, in fact, be a large number of such production devices arranged along the horizontal portion 132. Each production device 134 may have one or more associated flow control devices (also referred to as “inflow control devices” or ICDs or “passive inflow control devices”) 138 configured to govern one or more aspects of the flow of one or more fluids from the production zones into the production string 120. Production devices 134 are installed to control reservoir heterogeneities (permeability variations), high mobility ratio (reservoir permeability divided by fluid viscosity), heel to toe effect (high differential pressure in the production tubing) and/or high contrast in the reservoir pressure. As used herein, the term “fluid” or “fluids” includes liquids, gases, hydrocarbons, multi-phase fluids, mixtures of two of more fluids, water and fluids injected from the surface or fluids produced from the reservoir. Additionally, references to water should be construed to also include water-based fluids; e.g., brine or salt water. In accordance with embodiments of the present disclosure, the flow control device 138 may have a number of alternative structural features that provide selective operation (such as a sliding sleeve integrated with an inflow control device) and controlled fluid flow therethrough.

Subsurface formations typically contain water or brine along with oil and gas. Water may be present below an oil-bearing zone or from a lateral well. Gas may be present above such a zone. A horizontal wellbore section, such as section 110b, is typically drilled through a production zone, such as production zone 116, and may extend to more than 5,000 feet in length. Depending upon the geology of the production zone, longer the horizontal section, lower the drawdown because the fluid influx (barrel per foot) is distributed along the entire horizontal section. Once the wellbore has been in production for a period of time, water often flows into some of the flow control devices 138. The amount and timing of water inflow generally varies along the length of the production zone, but normally the water arrives to the wellbore sections proximate to the reservoir areas that have lower flow resistance in the porous media (i.e., reservoirs having low permeability). In general, it is desirable to have an even flow from the various flow control devices in a horizontal wellbore. It is also desirable to have flow control devices that will restrict the flow of fluids when water is present in the production fluid. In an aspect, by restricting the flow of production fluid containing water, the flow control device enables more oil to be produced over the production life of the production zone. In addition, in some production zones, it is desirable to have flow control devices that will restrict the flow of fluids when gas is present in the production fluid. This may also lead to increased production of hydrocarbons such as oil over the life of the zone.

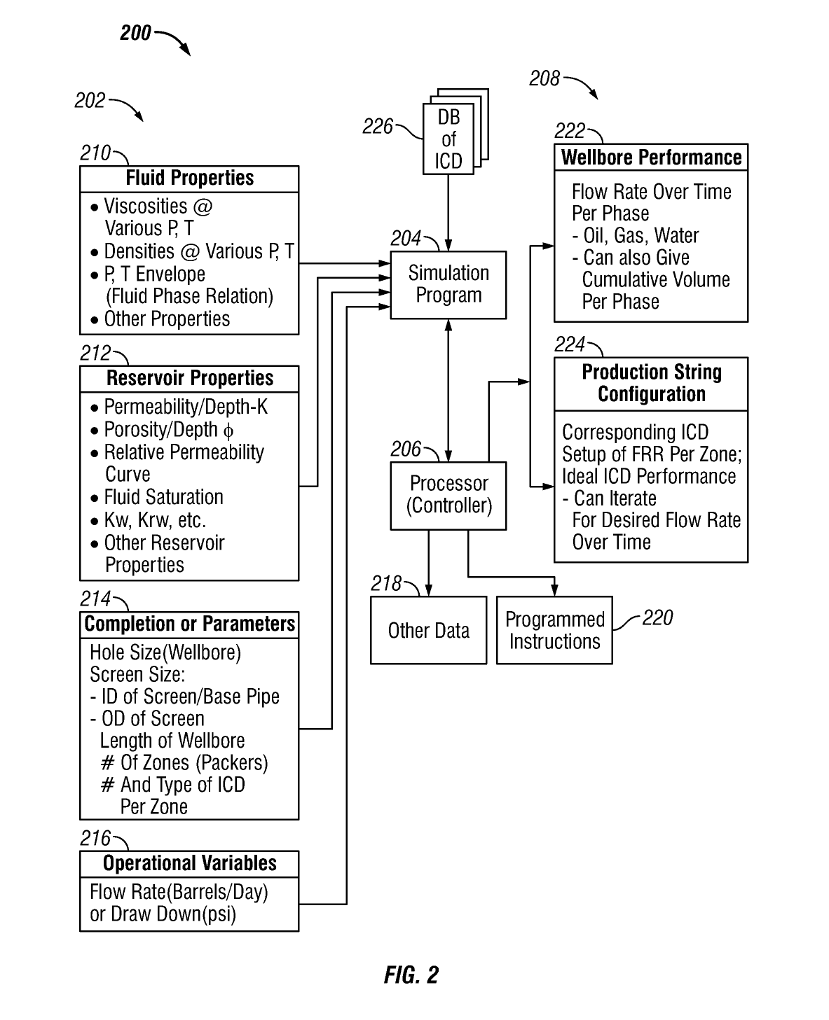

FIG. 2 is a block diagram of an exemplary system 200 that may be used to determine a production string layout and configuration and/or design of ICDs for deployment into a wellbore. The system 200 includes a controller that includes a processor 206 that utilizes programmed instructions 220, a simulation program or model 204 and other data 218 to determine a production string layout and types of ICD's and their geometries or configurations for use in the production string that is expected to satisfy an objective function or provide desired results. The simulation program 204 also may be used to determine the number of packers for an open hole completion. In the gravel pack completion packers are not used. The simulation program 204 utilizes a number of inputs or information 202 to compute the results or perform the simulation. The processor 206 runs the simulation program 204. The simulation program 204 may further utilize information from a data base that has information useful for running the simulation, including data on a variety of ICDs and other devices that may be utilized in the wellbore. The processor 206 runs the simulation program to provide the outputs 208.

In aspects, the inputs 202 may include, but not limited to fluid properties 210, reservoir properties 212, completion parameters 214 and operational variables 216. The simulation program 204 is utilized by the processor 206 (or controller) and it accesses other data 218 and programmed instructions 220 to execute the simulation program 204. The simulation program 204 may also access a database 226 that includes information for each of the flow devices that are available for use in the production string. The outputs 208 include, but are not limited to, simulated wellbore performance information 222, production string layout and configuration of production devices, including flow control devices 224, as explained in more detail below. The simulation program 204 endeavors to select the optimum inflow control devices from the database of available devises and/or may provide new geometries that will satisfy a selected objective function. In one configuration, the simulation program 204 may determine the new geometries for the flow control devices by performing multiple runs of computational fluid dynamics cases, where such cases are re-evaluated with the reservoir data.

Still referring to FIG. 2, the inputs 202 include information that may be gathered from logging-while-drilling (LWD), the operator(s), seismic surveys, existing data bases and pre-existing wells. In one aspect, the fluid properties 210 include the viscosities and densities of the production fluid at various pressures and temperatures. The fluid properties 210 also include the fluid and phase relationship over pressure, as well as other properties relating to the production fluid. The reservoir properties 212 may include, but are not limited to, permeability and porosity of the formation at selected depths. A relative permeability curve may be included in the reservoir properties 212. In addition, the reservoir properties 212 may include a measure of pressure loss of the production fluid, oil and water as compared to a Reynolds (Re) for the flow control devices (called passive inflow control flow performance characteristic).

The relative measure of pressure loss for oil, water and production fluid may be used by the simulation program 204 to determine a drill string configuration. Other wellbore and formation parameters, such as transmissibility, may also be used as inputs 202 to the simulation program 204.

In aspects, the inputs 202 to the simulation program include completion parameters 214, such as the wellbore hole size, the inner diameter of the base pipe, the outer diameter of the base pipe screen and the overall length of the wellbore. In one embodiment, the completion parameters may also include the number of zones in the wellbore, the arrangement of packers in the wellbore and the type of flow control devices used in the wellbore. In an aspect, all or a portion of this information may also be determined by the simulation program additional inputs. In another aspect, the operator may input all or a portion of the completion parameters 214. In addition, other parameters may also be included as part of the completion parameters 214. In aspects, the operational variables 216 are selected input parameters that may include values for a desired flow rate (barrels/day) and/or draw down (psi). Such information may be obtained from an operator or by software for optimizing reservoir production over the life of the well using a simulation model and other suitable methods. The simulation program 204 may utilize one or more of these variables to determine the production string layout, configuration for the production devices and ICDs and fluid flow properties. The flow rate is generally expressed in barrels per day and may be computed for the well (total production or flow rate) or from each production device in the drill string. The flow rate may also be expressed for each constituent of the production fluid, i.e., oil, water and gas. The flow rate for a wellbore typically will decrease over time, as the formation is drained of hydrocarbons. The term draw-down is related to the flow rate into the wellbore and is a measure of pressure difference between an end portion of the wellbore completion (closest to the heel in a horizontal well or closest to the top of the reservoir in a vertical well) and the reservoir. In an aspect, the operator may input a desired draw down, flow rate or tubing well head pressure (such as from a vertical lift performance curve) for the wellbore and the simulation program 204 uses this data, along with other inputs 202 to produce the outputs 208.

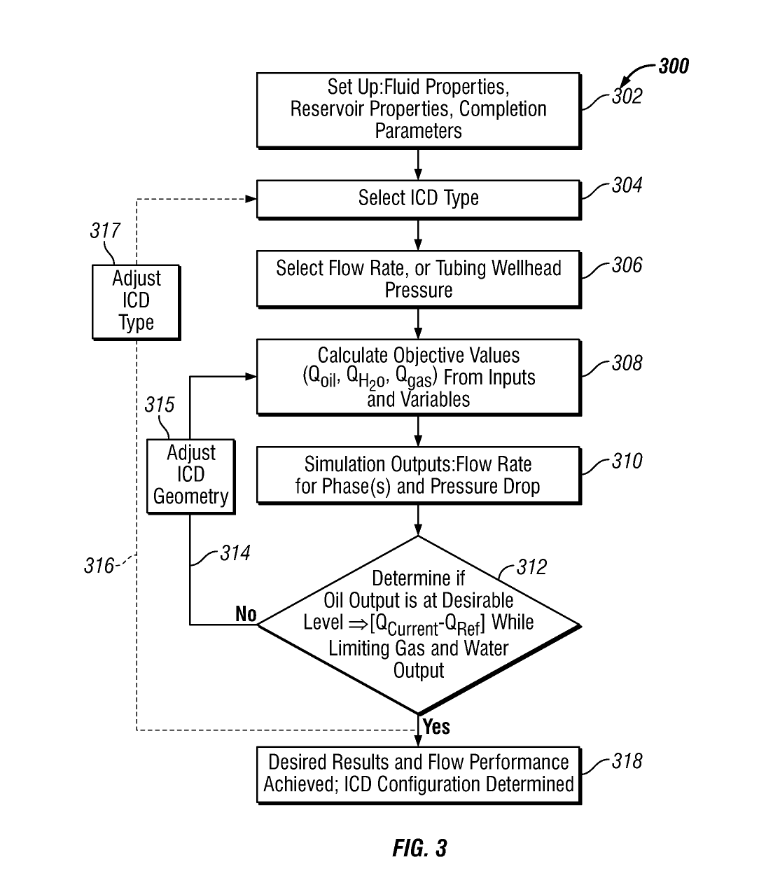

Still referring to FIG. 2, the outputs 208 include, but are not limited to, performance data 222 such as the actual flow rate (or predicted actual flow rate) over time for the wellbore and for oil, gas and water phases. In an aspect, the simulation program 204 may determine a selected flow rate over the wellbore life for each of the phases based on a desired result, such as an amount of oil produced. Further, the simulation program 204 may determine the flow rate based on acceptable levels of water and/or gas production. The process for determining optimal or desired levels of fluid production is discussed in detail below with respect to FIG. 3. In addition, the flow rate data 222 may include the cumulative volume of each fluid (oil, gas, water) produced over a given time period.

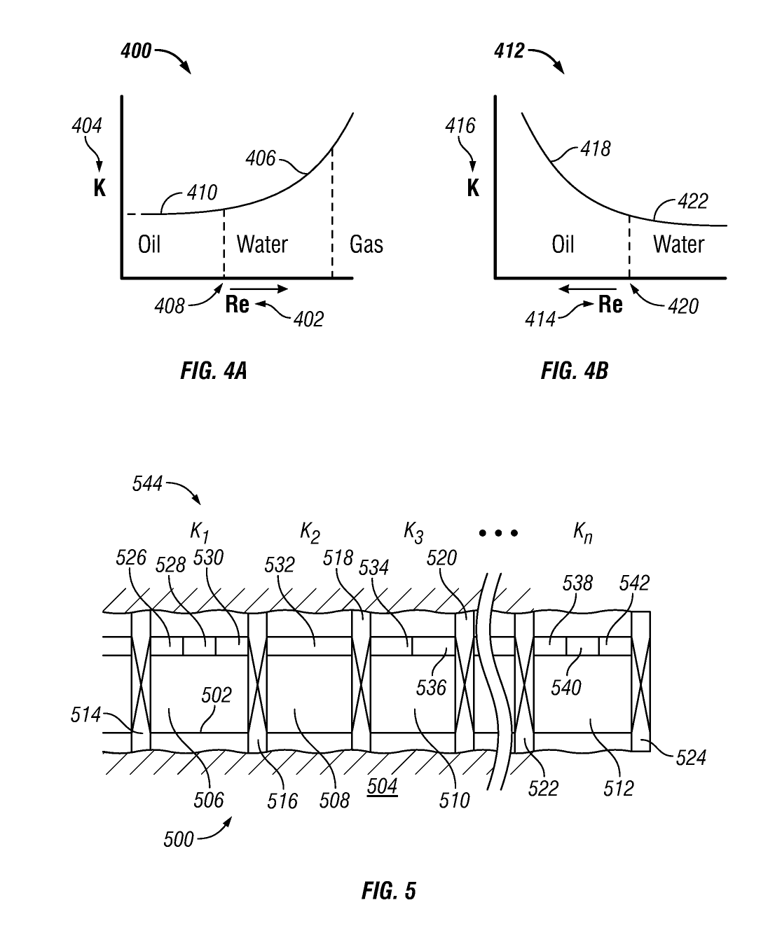

In aspects, the production string configuration 224 may have a corresponding flow resistance rating (FRR) for each production zone in the wellbore, wherein the FRR is determined by the simulation program. FRR is the pressure drop for fluid at particular flow rate through a given ICD type and geometry. In aspects, FRR is used to select the ICD geometry that, which is used by the simulation program 204. The program can select uniform or variable setting ICD design to satisfy the objective function. The uniform setting design is a viable option if there exists a good understanding of the ICD flow performance characteristic since the fluid flow control will be handled automatically by the ICD geometry, depending on the fluid properties (such as fluid density and viscosity), as is shown in the FIGS. 4A and 4B. Otherwise, variable setting ICD design may be selected when good understanding of the reservoir properties (such as permeability and pressure), since the program will allocate more ICD pressure drop in reservoir areas that have less flow resistance in the porous media (i.e., high permeability). The determined FRR may be correlated to the selected flow control device geometry for each zone. Thus, a configuration for a plurality of flow devices for a selected production zone may produce a desired level of oil along with an acceptable amount of water. The database 226 provides a list of available flow control device types and their geometries, as well as their flow performance characteristics, such as a FRR for each device. In an aspect, the simulation program 204 may determine a desired flow resistance rating for each production zone and utilize the database 226 to select the corresponding flow control device(s) to achieve the desired performance. In another aspect, the simulation program 204 determines the desired FRR for each production zone or devices in each zone. The program 204 may then determine a custom or hypothetical ICD type and geometry necessary to achieve the desired performance for the wellbore. The ICD's may be selected from a set of currently available ICD's that closely match the desired devices or may be custom designed to meet the desired well flow performance. In aspects, such selected ICDs may utilized in different types of reservoir (sandstone or carbonate), types of wells (production wells or injection wells) or types of fluid (light, medium or heavy oil, gas, gas condensate).

FIG. 3 shows a flow chart of an exemplary method or process 300 for determining a production string layout in a wellbore. The routine 300 may run on a processor 206 which uses a simulation program 204 and other inputs to select a configuration for flow control devices (ICDs) in a wellbore. The routine begins (Block 302) by gathering inputs to set up the system, wherein the inputs include one or more fluid properties, reservoir properties and completion parameters, as described above in FIG. 2. After selecting or determining the inputs, an ICD type is selected in Block 304. The ICD type may be selected based on fluid properties, formation conditions and corresponding available ICD geometries. The ICD type may also be selected by a user-based desired flow performance based on fluid properties, such as those discussed below in FIGS. 4A and 4B. For example, an ICD type may be selected to restrict flow of water while enabling flow of oil. In an aspect, the ICD type may be selected from any ICD type, including, but not limited to helical, orifice, hybrid, screen or any combination thereof. An ICD may be selected to increase pressure drop across the flow control device as the amount of an undesirable fluid, such as water and/or gas increases. In other aspects, the simulation program 204 may determine the ICD type based on input data. The operator may then establish a desired flow rate for the wellbore (Block 306). As discussed above in reference to FIG. 2, the operator may alternatively select the draw down (or flow rate or tubing well head pressure) in Block 306. In Block 308, a processor may use a simulation program to calculate the objective value or function for the routine 300 based on the selected ICD type, fluid properties, reservoir properties, completion parameters and additional inputs. The objective values may be flow rates (Q) (such as Qₒᵢₗ, Q_{H2O}, G_{gas} and cumulative production rate or equal amount of fluid coming into the wellbore) for each phase determined by the simulation program 204 (FIG. 2), wherein a model determines the flow rates for the formation using the inputs.

After determining the objective values for the wellbore conditions, the simulation program 204, in one aspect, produces the outputs (Block 310) based on the previous Block parameters (Blocks 302-308) and a first configuration for the ICDs in the production string. The simulation outputs may include the flow rate for each fluid phase produced as well as pressure drops. The flow rates and pressure drops may be determined for each ICD in the tubular and for the entire wellbore completion (all ICDs). In Block 312, the simulation determines if the oil output is optimized as compared to a reference value (for example whether Q_{current}-Q_{reference} is at a desirable level or an economic key performance indicator is achieved) (also referred to as performance criterion). The reference value may be zero in the first iteration. In subsequent iterations of the simulation, the reference may be the simulated value closest to the established rates from Block 306. For example, if a value of 4580 barrels of oil per day is determined in a first iteration and, in a second iteration, Block 312 determines that 5938 barrels (e.g., because the ICD will deliver a better performance at higher flow rate) are produced for a given configuration of flow devices in the wellbore, then the method 300 may determine that the second iteration's configuration is the new reference value. In aspects, if the reference value is not exceeded, then the simulation may iterate again, as shown by arrow 314. In an aspect, the Block 312 may also compare the simulation output to the established flow rate from Block 306, wherein the flow rate closest to the established value enables the routine to proceed. Any suitable parameters may be evaluated in Block 312, including flow rate and/or FRR, wherein the parameters are determined for each production zone as well as for the entire wellbore. If the level of simulated production does not meet the objective value, then the routine may loop back to a selected functional block. In loop 314, the routine may adjust or alter the geometry of one or more flow devices in the wellbore (Block 315), and return to Block 308 to determine the objectives and run the simulation program again. The geometry of the flow devices may be altered by changing orifice sizes, size and number of flow channels, screen configurations and sizes, hybrid configurations, number of turns around a tubular for a helical type, or any other suitable alteration to affect the flow of liquids through the device. If the desired results are achieved in Block 312, the performance parameters for each production zone may be used to select the appropriate flow configuration devices for each zone in a wellbore (Block 318). In an aspect, the type of ICD is determined in Block 304 and a set of dimensions for the selected ICD are used to determine performance of the wellbore completion. For instance, if a hybrid type ICD is selected (Block 304) and a FRR of 3.2 is determined (Block 312) to provide the desired performance for a selected zone, then corresponding geometries for one or more hybrid type ICDs may be selected to produce the 3.2 FRR in that zone (Block 318). Other types of ICDs or a mixture of different types of ICDs may be selected for a selected FRR. The values of FRR may vary, such as from 0.2 to 3.2 or higher. As discussed in reference to FIG. 2, a database of available ICD types and their geometries may be available to the simulation program 204. In another aspect, the routine 300 may iterate through various ICD types (Arrow 316 and Block 317) during wellbore evaluation. For example, the “best” geometry configuration may be determined for a first ICD type and may be compared to the “best” geometry configuration for a second ICD type to determine an optimal wellbore configuration. In one embodiment, the routine 300 may iterate through combinations of different ICD types to determine the optimal overall configuration to produce the desired results. For instance, a selected wellbore may include a combination of helical and maze type ICDs.

FIGS. 4A and 4B show graphs 400 and 412, respectively, of desired performance curves for flow control devices expressed as a relationship between Reynolds number “Re” and pressure loss coefficient “K.” The Re is shown along the horizontal axis (402, 414) and K along the vertical axis (404, 416). Reynolds number Re is dimensionless and is a ratio between inertia forces and viscous forces. Re for fluids may be expressed as:

Re=Inertia forces/viscous force

Re=ρvD/μ,

wherein ρ is density of the fluid, v is the fluid velocity, D is a dimension of the flow area, such as diameter of an opening, and μ is the viscosity of the fluid. The Reynolds number for low viscosity fluids, such as water is relatively high compared to the high viscosity fluids, such as oils. Further, gas may have a relatively higher Reynolds number than water. Re may also be expressed as:

Re=f(density, viscosity, fluid velocity and surface dimension(s))

Pressure drop Dp across a flow area A may be expressed as:

Dp=K.(ρ).v²,

The pressure loss coefficient K is a function of Reynolds number Re (K=f(Re)). K also is a function of the geometry of the flow path of the fluid through the flow control device and in particular the tortuosity of the flow path within the flow control device. Therefore, inducing turbulence in the flow of a fluid affects the pressure drop of fluids of different viscosities, as described in more detail later. The pressure loss coefficient K may be expressed as:

K=f(Re, opening size, tortuosity).

In an aspect, graph 400 shows that it is desirable to have a flow control device that exhibits a high value of pressure loss coefficient K for fluids with a Reynolds number higher than the Reynolds number for water 408 and gas, in an oil well application, as shown by the curve segment 406. Graph 400 also shows that it desirable to have a relatively constant pressure loss coefficient K for Reynolds numbers less than the Reynolds number for water 408, in an oil well application, as shown by the curve segment 410. As a result of the performance illustrated by graph 400, the corresponding flow control device (ICD) resists flow of water and gas, while allowing a flow of oil through the flow control device channels. In one aspect, the graph 400 may correspond to a maze and/or hybrid type ICD, and may be used by an operator to select the appropriate ICD type during the routine 300 (FIG. 3).

Similarly, graph 412 shows that in one embodiment it is desirable to have a flow control device that exhibits a high value of pressure loss coefficient K for fluids with a Reynolds number lower than the Reynolds number for water 420, as shown by the curve segment 418. Graph 412 also shows that, in aspects, it desirable to have a relatively constant pressure loss coefficient K for Reynolds numbers greater than the Reynolds number for water 420, in a gas well application, as shown by the curve segment 422. As a result of the performance illustrated by graph 412, the corresponding flow control device (ICD) resists flow of oil and/or water in a gas well and allows flow of fluids with higher Re, such as gas, through the device. In one aspect, the graph 412 may correspond to a helical type ICD to enable a gas flow from a wellbore, and may be used by an operator to select the appropriate ICD type during the routine 300 (FIG. 3). The ICD flow performance characteristic observed in FIGS. 4A and 4B may be exaggerated or modified changing the ICD geometry. Accordingly, graphs 400 and 412 illustrate the performance of two examples of desired ICDs that may be utilized by the simulation program 204 to complete a wellbore. The type and geometry of the ICD selected and corresponding performance may be determined by the formation data or other parameters that are used to evaluate wellbore production. Other performance data and characteristics may be utilized by the simulation program 204 and system operators to provide desired production from a wellbore. In other aspects, an ICD may be selected to provide desired pressure drops for particular fluid types. For example, in one aspect, the ICD may be selected to provide high pressure drop for water (relative to oil) and/or high pressure drop for gas (relative to oil). In another aspect, the ICD may be selected to provide high pressure drop for a fluid having viscosity or density in one range and a substantially constant pressure drop for a fluid having viscosity or density in another range. For example, the device may provide high pressure drop for water or gas and a substantially constant pressure drop for oil.

The overall behavior of a fluid flow through an ICD depends upon the rheology of the fluid. Rheology is a function of several parameters, including, but not limited to, flow area, tortuosity, friction, fluid velocity, fluid viscosity and fluid density. In aspects, rheology parameters may be calculated or assumed to provide flow control devices that will inhibit water and/or gas flow. The disclosure herein utilizes fluid rheology principles and other factors noted above to provide flow control devices that inhibit flow of fluids with viscosity or density in one range and allow a substantially constant flow of fluids with viscosity or density in another range.

Referring now to FIG. 5, there is shown one embodiment of a portion of an exemplary drill string 500 that includes flow control devices located in production zones. The drill string 500 includes a base pipe or tubular 502 located in a drilled wellbore within a formation 504. The tubular 502 includes production zones 506, 508, 510 and 512. In aspects, a plurality of production zones may included in the horizontal and/or vertical portions of a wellbore. As depicted, production zone 506 is defined by packers 514 and 516. The packers 514 and 516 are devices capable of sealing portions of a drill string 500 within the formation 504. The production zone 504 includes flow control devices 526, 528 and 530. Packers 516 and 518 are located at the ends of production zone 508, which is shown to include a single flow control device 532. Flow control devices 534 and 536 are included in production zone 510, which is formed by packers 518 and 520. In addition, packers 522 and 524 define production zone 512, which includes flow control devices 538, 540 and 542. The packers may be used to isolate production zones within the wellbore, enabling customized fluid extraction and treatment within each production zone, thereby enhancing overall wellbore oil production. As previously discussed, the type and geometry of each ICD within a production zone may be determined by the simulation program 204 (FIG. 2). The size, location and number of production zones may be determined based on selected parameters, including fluid characteristics and formation properties such as permeability 544 (k₁, k₂, etc.) for regions of the formation. This information may be used by the simulation program to configure the production zones and flow control devices to produce a desired amount of oil, gas and water from the formation. For example, production zone 506 may include the flow control devices 526, 528 and 530 configured restrict water flow (FIG. 4A) and have a desired FRR, due to the permeability (k₁) of the area. In addition, production zone 508 may include the flow control device 532 configured to restrict gas flow (FIG. 4B) due to permeability (k₂) and the location of formation fractures in the area. Such an ICD setting design is considered in open annulus cases. The ICD setting design in a gravel pack is similar but the packers are not considered.

It should be understood that FIGS. 1-5 are intended to be merely illustrative of the teachings of the principles and methods described herein and which principles and methods may applied to design, construct and/or utilize inflow control devices for a wellbore. Furthermore, foregoing description is directed to particular embodiments of the present disclosure for the purpose of illustration and explanation. It will be apparent, however, to one skilled in the art that many modifications and changes to the embodiment set forth above are possible without departing from the scope of the disclosure.

1. A method of providing a production string for a wellbore formed in a formation, comprising:
defining a performance criterion for flow of a fluid from a formation into a wellbore;
performing a simulation using a processor, a simulation program, a parameter of the fluid, a parameter of the formation and a parameter of the wellbore to determine a first flow characteristic of the flow of the fluid from the formation into the wellbore corresponding to an initial set of flow control devices arranged in the wellbore;
performing one or more additional simulations using the processor, the simulation program and the parameters of formation, fluid and wellbore to determine a new flow characteristic of the flow of the fluid from the formation into the wellbore for a new set of flow control devices until a new determined characteristic of the flow of the fluid from the formation into the wellbore meets the performance criterion; and
storing results of simulation results relating to the flow control devices in a suitable storage medium.

2. The method of claim 1, further comprising making a production string using the flow control devices that meet the performance criterion.

3. The method of claim 1, wherein the formation property is one of: porosity, permeability, pressure and temperature, and fluid saturation.

4. The method of claim 1, wherein the fluid property is one of: viscosity, density, fluid phase relation, Reynolds number and a friction coefficient for the fluid.

5. The method of claim 1, wherein the wellbore property is one of: hole size, a wellbore length, a screen dimension, number of production zones, and production tubing size, and number of flow control devices in the wellbore.

6. The method of claim 1, wherein a flow control device used in the initial or new set of flow control devices is a device that exhibits one of: a first pressure drop when a selected property of the fluid is in a first range and exhibits a second substantially constant pressure drop when the selected property of the fluid is in the second range.

7. The method of claim 1, wherein the first range includes one of: (i) viscosities below about 10 cP; and (ii) densities above about 8.33 lbs per gallon.

8. The method of claim 1, further comprising defining number of production sections in production before performing the simulation to determine the initial flow characteristic.

9. The method of claim 6, wherein the flow control device induces one or more tortuous paths that cause turbulence in the flow of the fluid through the flow control device to reduce a flow area therein to crate the pressure drop.

10. The method of claim 1, wherein the performance criterion is one of: maximum flow rate of oil and minimum flow rate of water or gas over a time period.

11. The method of claim 1, wherein the initial or the new flow characteristic is a flow resistance rating.

12. The method of claim 1, wherein the performance criterion includes one or more of: total flow rate, flow rate of oil, flow rate of gas, and substantially equal flow rate from each of a plurality of production sections.

13. A computer-readable medium, accessible to a processor for executing instructions contained in program embedded in the computer-readable medium, the program comprising:
instructions to select a performance parameter for flow of a fluid from a formation into a wellbore;
instructions to use a simulation program, a parameter of the fluid, a parameter of the formation and a parameter of the wellbore to determine an initial flow characteristic of the flow of the fluid from the formation into the wellbore corresponding to an initial set of flow control devices arranged along the wellbore;
determining whether the initial flow characteristic meets a selected performance parameter;
instructions, when the performance criterion is not met, to repeat performing simulation using the simulation program and a new set of flow control devices to determine a new characteristic that meets the performance criterion; and
storing a simulation result in a suitable storage medium.

14. The computer-readable medium of claim 13, wherein the program further comprises:
Instructions to provide a production string layout with a set of flow control devices that meet the performance criterion.

15. The computer-readable medium of claim 13, wherein the formation parameter is one of: porosity, permeability, pressure and temperature, and fluid saturation.

16. The computer-readable medium of claim 13, wherein the fluid property is one of: viscosity, density, fluid phase relation, Reynolds number and a friction coefficient for the fluid.

17. The method of claim 13, wherein the wellbore property is one of: hole size, a wellbore length, a screen dimension, number of production zones, and production tubing size, and number of flow control devices in the wellbore.

18. The computer readable medium of claim 13, wherein the program further includes: instructions to include in the set of flow control devices a flow control device that exhibits a substantial pressure drop when a property of the fluid is in a first range and exhibits substantially a constant pressure drop when the property of the fluid is in the second range.

19. The computer-readable medium of claim 18, wherein the first range includes one of: (i) viscosities below about 10 cP; and (ii) densities above about 8.33 lbs per gallon.

20. The computer-readable medium of claim 13, wherein the program further includes instructions to select number of production sections for the wellbore before performing the simulation to determine the initial flow characteristic of the flow of the fluid from the formation into the wellbore.

21. The computer-readable medium of claim 18, wherein the program further comprises instructions to include a flow control device in the initial or new set of flow control devices that has a tortuous path that causes turbulence in the flow of the fluid through such flow control device to reduce a flow area through such flow control device to crate the pressure drop.

22. The computer-readable medium of claim 13, wherein the performance criterion is maximum total flow rate of oil and minimum flow rate of water or gas over a time period.

23. The method of claim 1, wherein a flow control device used in the initial or new set of flow control devices is a device that exhibits one of: a pressure drop for water that is grater than a pressure drop for oil; a pressure drop for gas that is grater than a pressure drop of oil; a relatively constant pressure drop for oil and a pressure drop of water that is greater than the relatively constant pressure drop for oil; a substantially constant pressure drop for oil and a pressure drop for gas that is greater than the substantially constant pressure drop for oil; and a pressure drop for gas that is less than a pressure drop of oil or water.
